(19) United States
(12) Patent Application Publication
(10) Pub. No.: US 2025/0281350 A1
(43) Pub. Date: Sep. 11, 2025

(54) VIBROACOUSTIC DEVICES, SYSTEMS, AND METHODS FOR PROMOTING REST

(71) Applicant: Munchkin Incorporated, Van Nuys, CA (US)

(72) Inventors: Jaime Sanchez Solana, Culver City, CA (US); Agnes Yena Lee, Los Angeles, CA (US); Yuyao Tian, Northridge, CA (US); Yifan Ding, Somerville, MA (US); Veronica M Mora, Pasadena, CA (US); Michael Thomas Dillane, Los Angeles, CA (US)

(73) Assignee: Munchkin Incorporated, Van Nuys, CA (US)

(21) Appl. No.: 19/076,786

(22) Filed: Mar. 11, 2025

Related U.S. Application Data
(60) Provisional application No. 63/563,958, filed on Mar. 11, 2024.
(60) Provisional application No. 63/766,335, filed on Mar. 3, 2025.

(51) Int. Cl. A61H 23/02

(52) U.S. Cl. CPC A61H 23/0236; A61H 2201/503; A61H 2201/5097; A61H 2203/0443

(57) ABSTRACT

Vibroacoustic systems, devices, and methods for using the same are presently disclosed. An example method can include generating, using a vibroacoustic device having a vibroacoustic speaker and an acoustic speaker, a first combination of vibrations and acoustic noises, generating, using the vibroacoustic device, a transition combination of vibrations and acoustic noises, wherein the transition combination is a gradual transition of intensity of vibrations and volume of acoustic noises from the a first intensity and volume of the first combination to a second intensity and volume of a second combination of vibrations and acoustic noises, and generating, using the vibroacoustic device, the second combination of vibrations and acoustic noises.

### CROSS-REFERENCE TO RELATED APPLICATIONS

This patent application claims the benefit of and priority to U.S. Provisional Patent Application No. 63/563,958, filed on Mar. 11, 2024, entitled “VIBROACOUSTIC DEVICES AND SYSTEMS FOR PROMOTING REST,” and U.S. Provisional Patent Application No. 63/766,335, filed on Mar. 3, 2025, entitled “VIBROACOUSTIC DEVICES AND SYSTEMS FOR PROMOTING REST, both of which are expressly incorporated by reference herein in its entirety.

### TECHNICAL FIELD

The subject disclosure relates generally to vibroacoustic devices. More particularly, the present disclosure relates to vibroacoustic devices for promoting sleep or rest.

### BACKGROUND

Sleep is one of the most healthy and helpful methods of allowing our bodies to recoup and recover. It is universally needed, not only for all humans, but for animals as well. As society modernizes and the advent of non-stop distractions proliferates, the human mind becomes more distracted and cluttered. Thus, for millions of people in the U.S. and around the world, not just getting to bed, but being able to relax and fall asleep have become much more difficult.

Various drugs have been developed to induce rest and sleep. However, all of these drugs have certain side effects and run the risk of developing dependencies, as well as the risk of overdose.

For children, in particular, being able to promote rest and sleep, particularly with a nap or nighttime routine, is especially important, as such habits developed at childhood carry on into adulthood.

Not only parents, but all consumers, would benefit greatly in seeking non-medication techniques to induce rest or sleep. What is needed are devices and techniques that promote rest and sleep without the negative effects, dangers, and risks of drugs. Vibroacoustic devices are systems that produce or transmit vibrations and sound waves. They are commonly used in applications such as medical devices, industrial equipment, and musical instruments. These devices typically consist of a source of vibration (e.g., a speaker or a motor) and a shell or enclosure that transmits the vibrations to an external medium (e.g., air or water).

One of the key challenges in designing vibroacoustic devices is efficiently transmitting sound and vibration through the shell. The shell must be designed to optimize the transfer of energy from the source of vibration to the external medium, while minimizing energy loss or absorption. This can be achieved through various shell designs and materials, such as resonant cavities, acoustic lenses, and thin films.

### BRIEF SUMMARY

The present subject disclosure presents a simplified summary of the subject disclosure in order to provide a basic understanding of some aspects thereof. This summary is not an extensive overview of the various embodiments of the subject disclosure. It is intended to neither identify key or critical elements of the subject disclosure nor delineate any scope thereof. The sole purpose of the subject summary is to present some concepts in a simplified form as a prelude to the more detailed description that is presented hereinafter.

In one exemplary embodiment, the present subject disclosure is a vibroacoustic system. The vibroacoustic system can include a vibroacoustic device and control features. The vibroacoustic device can have a housing, a vibroacoustic speaker disposed in the housing, the vibroacoustic speaker configured to generate vibrations, and an acoustic speaker disposed in the housing, the acoustic speaker configured to generate acoustic sounds. The control features are configured to control the vibroacoustic device, wherein the control features cause the vibroacoustic device to generate coordinated vibrations and acoustic sounds.

In another exemplary embodiment, the present subject disclosure is a vibroacoustic device. The vibroacoustic device can include a housing; a vibroacoustic speaker disposed in the housing, the vibroacoustic speaker configured to generate vibrations; an acoustic speaker disposed in the housing, the acoustic speaker configured to generate acoustic sound; and a printed circuit board (PCB) in communication with the vibroacoustic speaker and the acoustic speaker, wherein the PCB causes the vibroacoustic speaker and the acoustic speaker to generate coordinated vibrations and acoustic sounds.

In another exemplary embodiment, the present subject disclosure is a method. The method can include generating, using a vibroacoustic device having a vibroacoustic speaker and an acoustic speaker, a first combination of vibrations and acoustic noises; generating, using the vibroacoustic device, a transition combination of vibrations and acoustic noises, wherein the transition combination is a gradual transition of intensity of vibrations and volume of acoustic noises from the a first intensity and volume of the first combination to a second intensity and volume of a second combination of vibrations and acoustic noises; and generating, using the vibroacoustic device, the second combination of vibrations and acoustic noises.

### BRIEF DESCRIPTION OF THE DRAWINGS

Various exemplary embodiments of this disclosure will be described in detail. The accompanying drawings, which are incorporated in and constitute a part of this specification, illustrate embodiments of the subject disclosure and technical data supporting those embodiments, and together with the written description, serve to explain certain principles of the subject disclosure. With reference to the following figures, wherein:

FIG. 1 illustrates an example vibroacoustic system, according to some aspects of the present disclosure.

FIG. 2 illustrates an example vibroacoustic device and remote control, according to some aspects of the present disclosure.

FIG. 3 is an exploded view of an example vibroacoustic device, according to some aspects of the present disclosure.

FIG. 4 is a top view of an example vibroacoustic device, according to some aspects of the present disclosure.

FIG. 5 is a bottom view of an example vibroacoustic device, according to some aspects of the present disclosure.

FIG. 6 is a lower perspective view of an example vibroacoustic device, according to some aspects of the present disclosure.

FIG. 7 is an upper perspective view of an example vibroacoustic device, according to some aspects of the present disclosure.

FIG. 8 is a side view of an example vibroacoustic device, according to some aspects of the present disclosure.

FIG. 9 is a cross-section view through section A-A in FIG. 5 of an example vibroacoustic device, according to some aspects of the present disclosure.

FIG. 10 illustrates an example vibroacoustic device attached to a crib, according to some aspects of the present disclosure.

FIG. 11 illustrates attachment of an example vibroacoustic device to a crib, according to some aspects of the present disclosure.

FIG. 12 illustrates an example vibroacoustic device attached to a frame of a crib, according to some aspects of the present disclosure.

FIG. 13 illustrates attachment of an example vibroacoustic device to a frame of a crib, according to some aspects of the present disclosure.

FIG. 14 illustrates an example vibroacoustic device positioned within parallel slats of a frame of a bed, according to some aspects of the present disclosure.

FIG. 15 is a close up view of an example vibroacoustic device positioned within parallel slats of a frame of a bed, according to some aspects of the present disclosure.

FIG. 16 illustrates an example vibroacoustic device attaching to a slat of a frame of a bed, according to some aspects of the present disclosure.

FIG. 17 is another view of a crib incorporating an example vibroacoustic device, according to some aspects of the present disclosure.

FIG. 18 is an exploded view of an example remote control, according to some aspects of the present disclosure.

FIG. 19 is a front view of an example remote control, according to some aspects of the present disclosure.

FIG. 20 is a rear view of an example remote control, according to some aspects of the present disclosure.

FIG. 21 is a perspective view of an example remote control, according to some aspects of the present disclosure.

FIG. 22 is a perspective view of a battery housing of an example remote control, according to some aspects of the present disclosure.

FIG. 23 is a cross-section view through section B-B in FIG. 20 of an example remote control, according to some aspects of the present disclosure.

FIG. 24 illustrates an example remote control and an example dock, according to some aspects of the present disclosure.

FIG. 25 illustrates a user attaching an example remote control to an example dock, according to some aspects of the present disclosure.

FIG. 26 illustrates an example remote control attached to an example dock, according to some aspects of the present disclosure.

FIG. 27 illustrates an example remote control attached to an example dock, according to some aspects of the present disclosure.

FIG. 28 illustrates an example system including an example vibroacoustic device, according to some aspects of the present disclosure.

FIG. 29 is a cross sectional view of an example vibroacoustic device, according to some aspects of the present disclosure.

FIG. 30 illustrates an example remote control, according to some aspects of the present disclosure.

FIG. 31 illustrates an example remote control and an example dock, according to some aspects of the present disclosure.

FIG. 32 illustrates an example vibroacoustic device, according to some aspects of the present disclosure.

FIG. 33 is a cross-section view through section C-C in FIG. 32, according to some aspects of the present disclosure.

FIG. 34 is a view of a stuffed animal incorporating a vibroacoustic device, according to some aspects of the present disclosure.

FIG. 35 shows an operation frequency of vibroacoustic therapy as compared to other acoustic uses, according to some aspects of the present disclosure.

FIG. 36 illustrates example operating levels of an example vibroacoustic device, according to some aspects of the present disclosure.

FIG. 37 illustrates an example method for facilitating sleep and/or rest using a vibroacoustic device, according to some aspects of the present disclosure.

### DETAILED DESCRIPTION

The following detailed description references specific embodiments of the subject disclosure and accompanying figures, including the respective best modes for carrying out each embodiment. It shall be understood that these illustrations are by way of example and not by way of limitation. Particular embodiments of a vibroacoustic device will now be described in greater detail with reference to the figures.

The present subject disclosure describes devices and techniques which promote rest and sleep by using vibroacoustic technology. The initial years of parenthood are a period when individuals strongly seek ways for maintaining enough sleep hours and high-quality sleep. The devices and techniques presented herein are geared towards optimization of the ambient environment for faster and deeper sleep by influencing biological internal rhythms. An example vibroacoustic system of this disclosure utilizes vibroacoustic frequencies to improve and promote sleep and/or rest. The vibroacoustic systems can be attached to sleeping areas, such as beds, cribs, and other rest areas. The vibroacoustic systems may have separate controls (e.g., using a remote control) for ease of access.

The present subject disclosure is based on ambient optimization where parents can turn their nursery room into a more soothing, perfect-to-sleep environment through sensational devices. However, the present subject disclosure is not limited to parents and children, but more broadly applicable to a wider demographic and age group. The present subject disclosure is mostly presented with respect to infants and small children, for sake of simplicity, but one of ordinary skill in the art would understand the broader applicability of the concept.

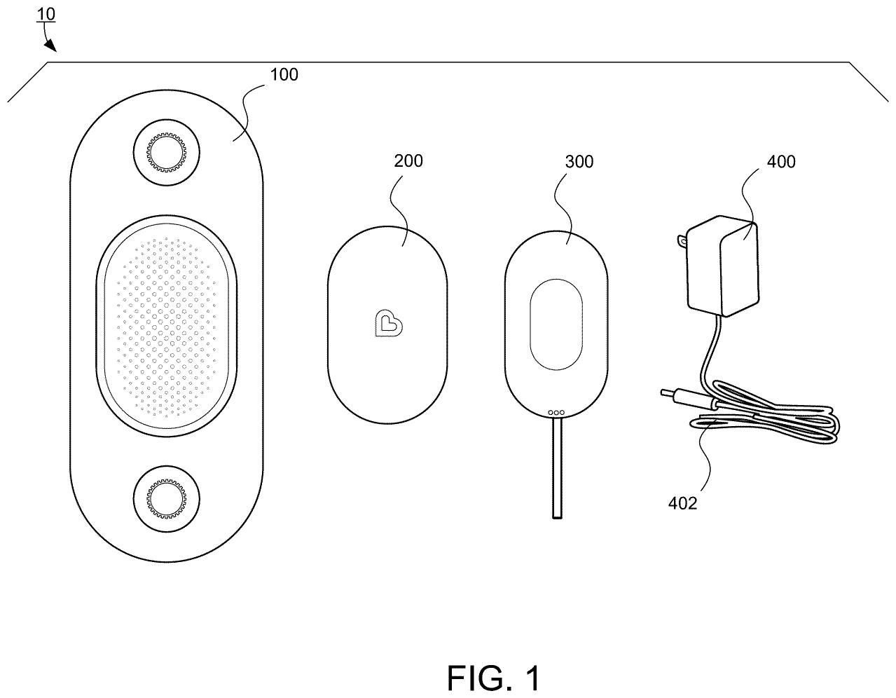

FIG. 1 illustrates an example vibroacoustic system 10, according to some aspects of the present disclosure. Vibroacoustic system 10 can include a vibroacoustic device 100, a remote control 200, a dock 300, and a charger 400. Vibroacoustic device 100 is configured to generate vibroacoustic frequencies to promote and facilitate sleep and rest. Remote control 200 is operable to control operations of vibroacoustic device 100. Dock 300 is configured to receive remote control 200. Charger 400 can provide power to vibroacoustic device 100, for example, by using a cable 402.

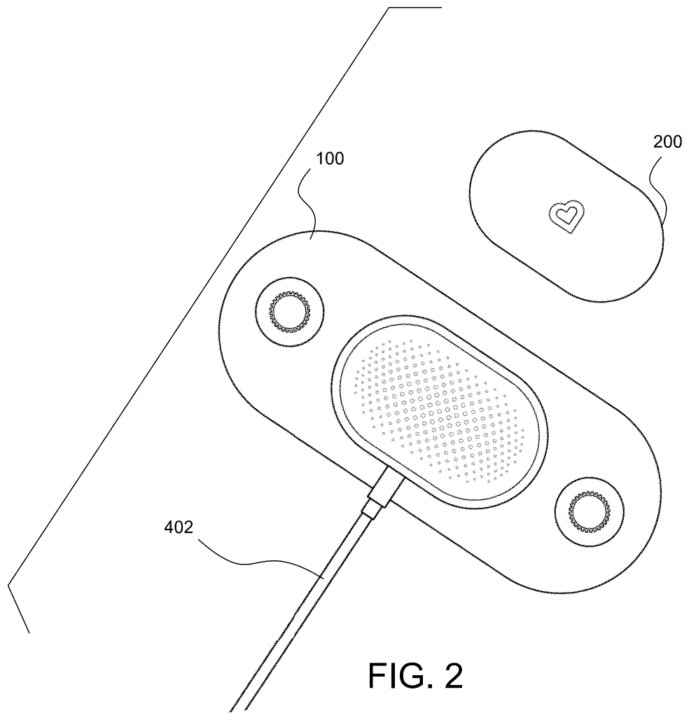

FIG. 2 illustrates an example vibroacoustic device 100 and remote control 200, according to some aspects of the present disclosure. Vibroacoustic device 100 is connected to a cable 402 to receive power. Additionally, remote control 200 can be used to control operations of vibroacoustic device 100.

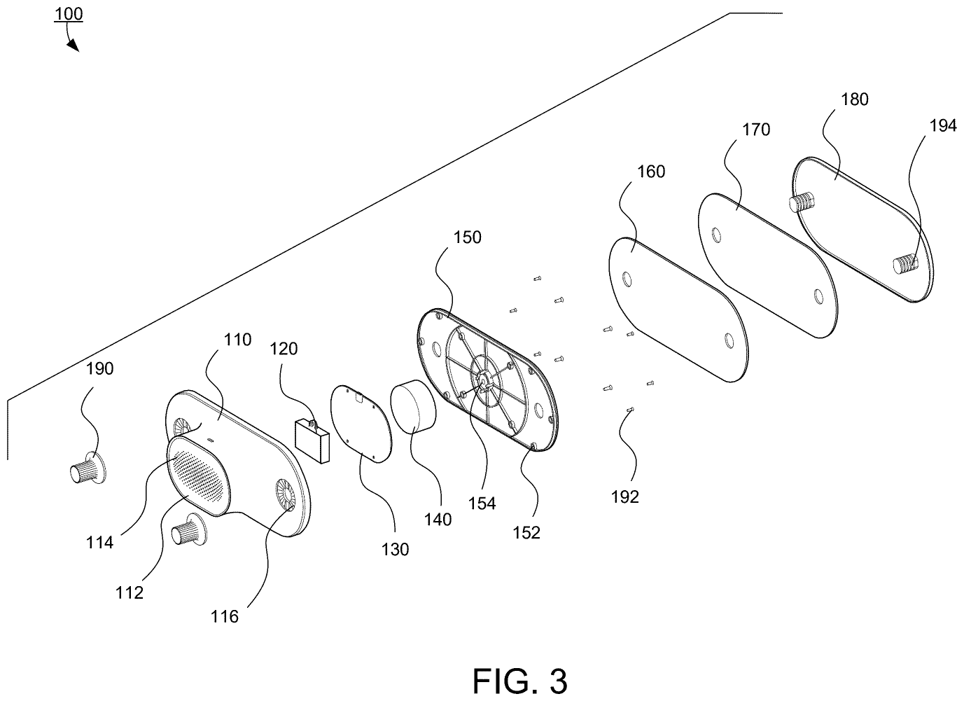

FIG. 3 is an exploded view of an example vibroacoustic device 100, according to some aspects of the present disclosure. Vibroacoustic device 100 includes a housing 110, a speaker 120, a circuit board 130, a vibroacoustic speaker 140, an assembly cover plate 150, a first rattle reduction layer 160, a second rattle reduction layer 170, and a top connection plate 180.

Housing 110 can have an elongated shape and an expanded central portion defining a storage compartment 112. Housing 110 may also be referred to as a shell. Storage compartment 112 is operable to contain speaker 120, circuit board 130, and vibroacoustic speaker 140 therein. A section of housing 110 for storage compartment 112 can have apertures 114 to allow acoustic waves to pass therethrough. Apertures 114 also provide cooling heat dissipation functionality for heat generated inside storage compartment 112. Housing 110 may also have one or more fastening areas 116 to facilitate fastening of various components of vibroacoustic device 100 together.

Speaker 120 is configured to generate acoustic sound waves. Speaker 120 can be in communication with circuit board 130 to receive signals from circuit board 130. For example, speaker 120 can generate acoustic sound waves for a lullaby when receiving a signal from circuit board 130. As another example, speaker 120 can increase and/or decrease a volume (e.g., by generating higher/lower magnitude acoustic sound waves) in response to a signal from circuit board 130 associated with a volume control command.

Circuit board 130 is configured to receive, generate, process, and communicate signals to and/or from speaker 120 and/or vibroacoustic speaker 140. Circuit board 130 is also configured to communicate with remote control 200 to send and/or receive signals from remote control 200. For example, remote control 200 can send signals to circuit board 130 to increase a vibration intensity generated by vibroacoustic speaker 140. Circuit board 130 can then generate and send a signal that causes vibroacoustic speaker 140 to increase the vibration intensity.

Vibroacoustic speaker 140 is configured to generate vibrations. As will be discussed in further detail below, vibroacoustic frequencies can provide various benefits and promote sleep and/or rest. Vibroacoustic speaker 140 can generate vibrations at varying levels of intensity, pattern, frequency, and the like. For example, vibroacoustic speaker 140 may generate stronger vibrations during one period of time and weaker vibrations during another period of time. It is to be understood that the vibroacoustic speaker 140 may also generate acoustic sound waves in addition to the generation of vibrations and may also produce characteristics similar to the speaker 120 as mentioned above.

Assembly cover plate 150 provides a cover for housing 110. Housing 110 and assembly cover plate 150 cover storage compartment 112, encasing speaker 120, circuit board 130, and vibroacoustic speaker 140 therein. Assembly cover plate 150 can include apertures 152 and a central aperture 154 to receive fasteners 192, for example, to secure assembly cover plate 150 to housing 110.

First rattle reduction layer 160 and second rattle reduction layer 170 are layers constructed of softer materials, which may be more efficient at absorbing noise and/or vibrations. These layers can also provide padding between different components (e.g., assembly cover plate 150 and top connection plate 180).

Top connection plate 180 and housing 110 can encase speaker 120, circuit board 130, vibroacoustic speaker 140, assembly cover plate 150, first rattle reduction layer 160, second rattle reduction layer 170. Top connection plate 180 can also include bolt 194 configured to align, fasten and secure the components inside of top connection plate 180 and housing 110. For example, bolt 194 can protrude through fastening areas (e.g., fastening area 116 of housing 110). Additional fasteners can also be used to secure housing 110 with top connection plate 180. For example, nut 190 can mate with bolt 194 to secure top connection plate 180 to housing 110. For example, nut 190 can secure housing 110, speaker 120, circuit board 130, vibroacoustic speaker 140, assembly cover plate 150, first rattle reduction layer 160, an object for securing vibracoustic device 100 to (e.g., slats of a bed), second rattle reduction layer 170, and top connection plate 180. Fasteners may also be used internally. For example, fastener 192 can be used to secure assembly cover plate 150 to housing 110.

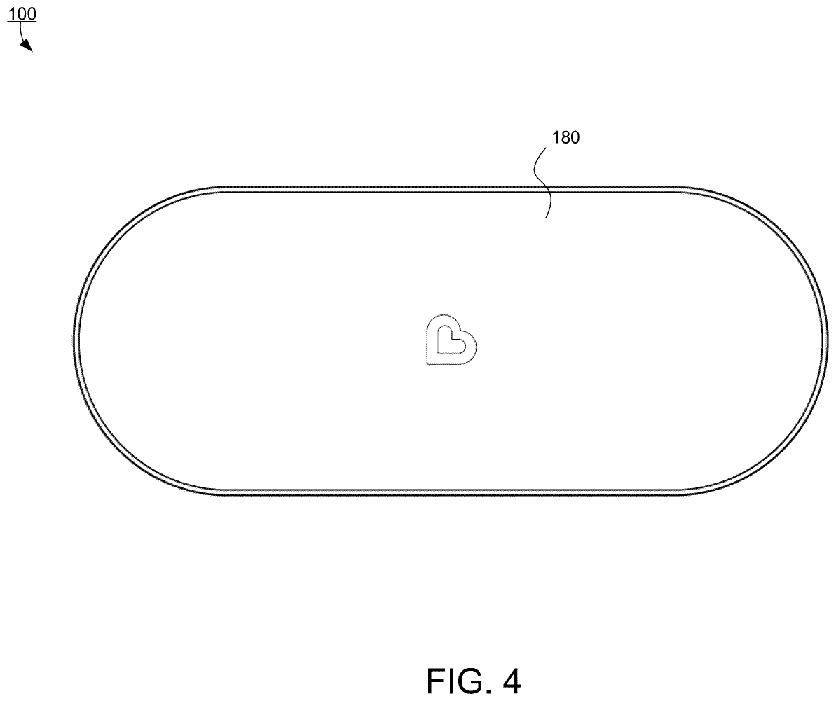

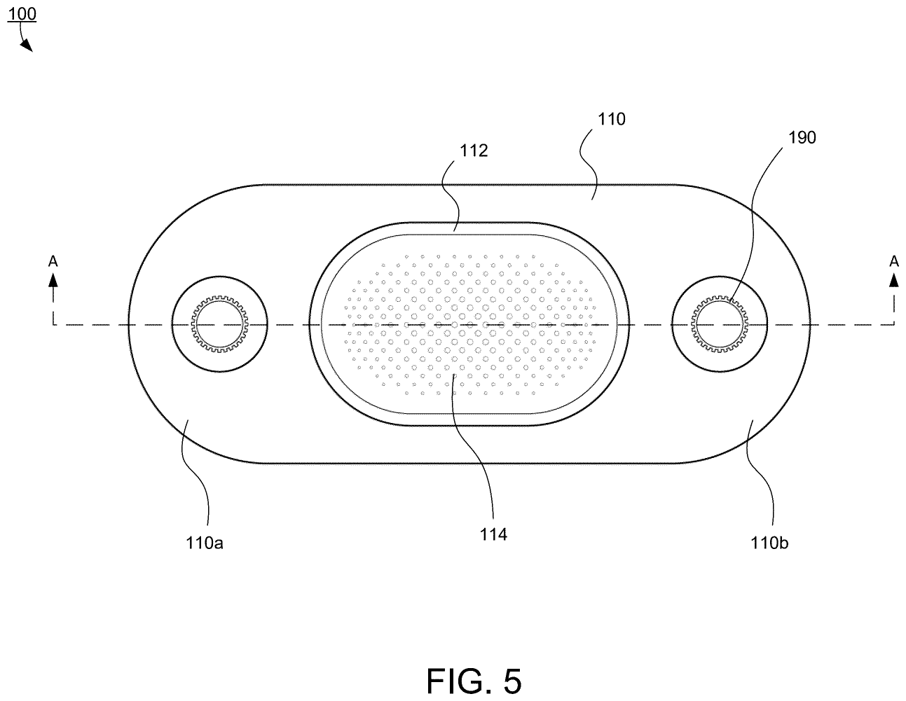

FIG. 4 and FIG. 5 are a top view and a bottom view, respectively, of an example vibroacoustic device 100, according to some aspects of the present disclosure. Vibroacoustic device 100 can include top connection plate 180 having a similar shape as an elongated portion of housing 110. The elongated portion of housing 110 can include a first longitudinal end 110a and a second longitudinal end 110b at distal ends of housing 110.

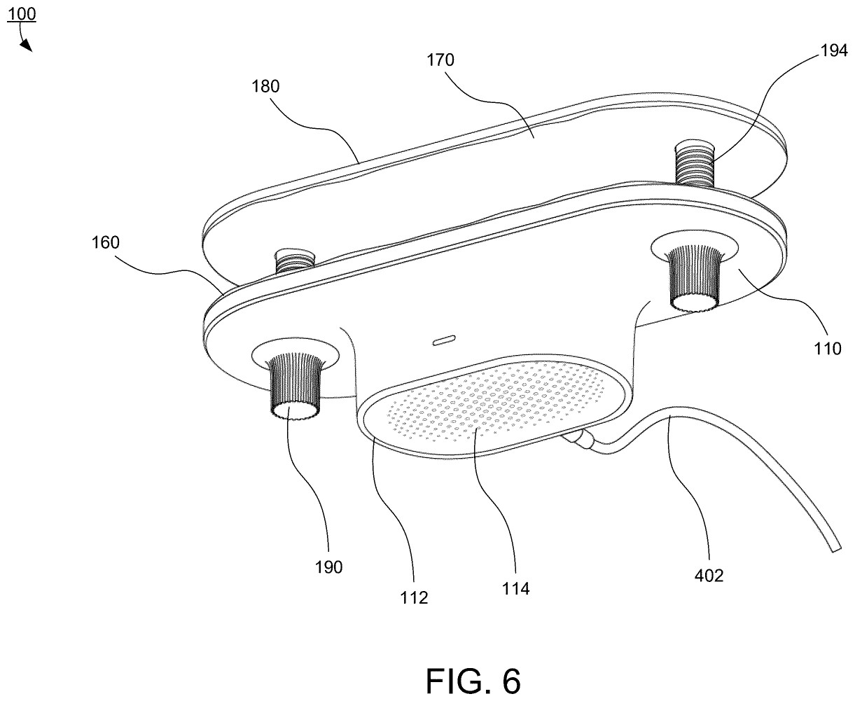

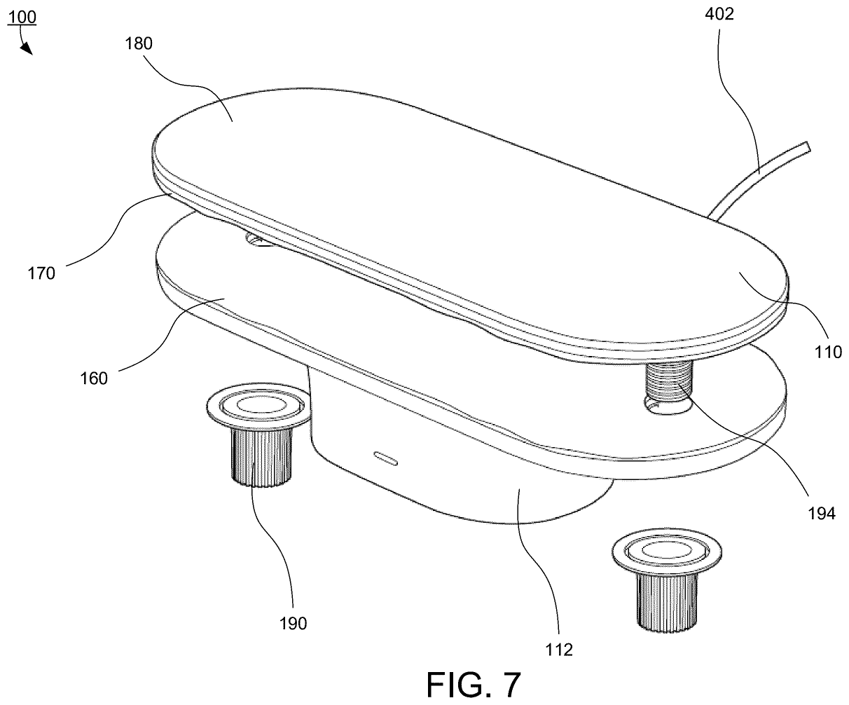

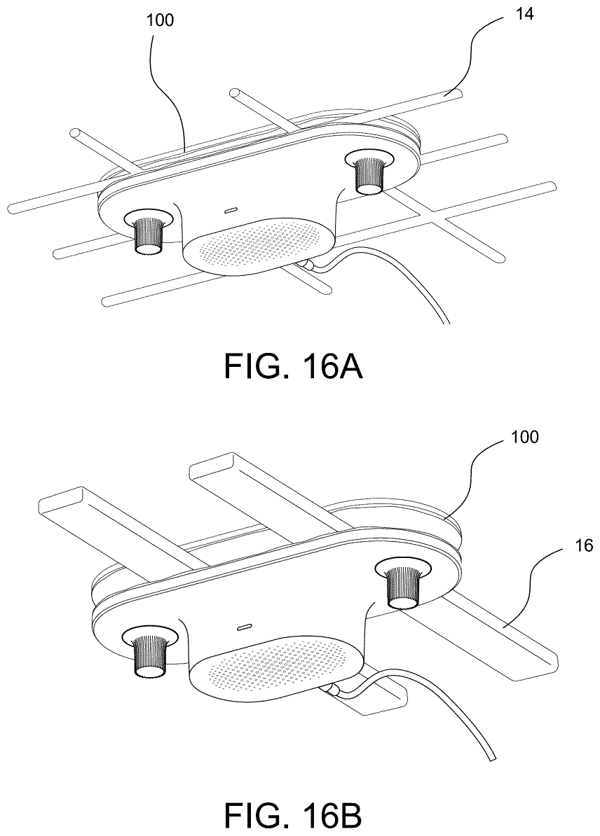

FIG. 6 and FIG. 7 are a lower perspective view and an upper perspective view, respectively, of an example vibroacoustic device 100, according to some aspects of the present disclosure. A first side of vibroacoustic device 100 can include housing 110, assembly cover plate 150, contents stored within housing 110 and assembly cover plate 150 (e.g., speaker 120, circuit board 130, and/or vibroacoustic speaker stored in storage compartment 112), and first rattle reduction layer 160. A second side of vibroacoustic device 100 can include second rattle reduction layer 170 and top connection plate 180. The first side and the second side can have a gap therebetween. The gap can be used, for example, to accommodate a surface for attaching vibroacoustic device 100 thereto. As will be discussed further below with respect to FIG. 16, vibroacoustic device 100 can sandwich slats between the first side and the second side. Bolts 194 and fasteners 192 can secure the first side and the second side, while also providing enough space to maintain the gap.

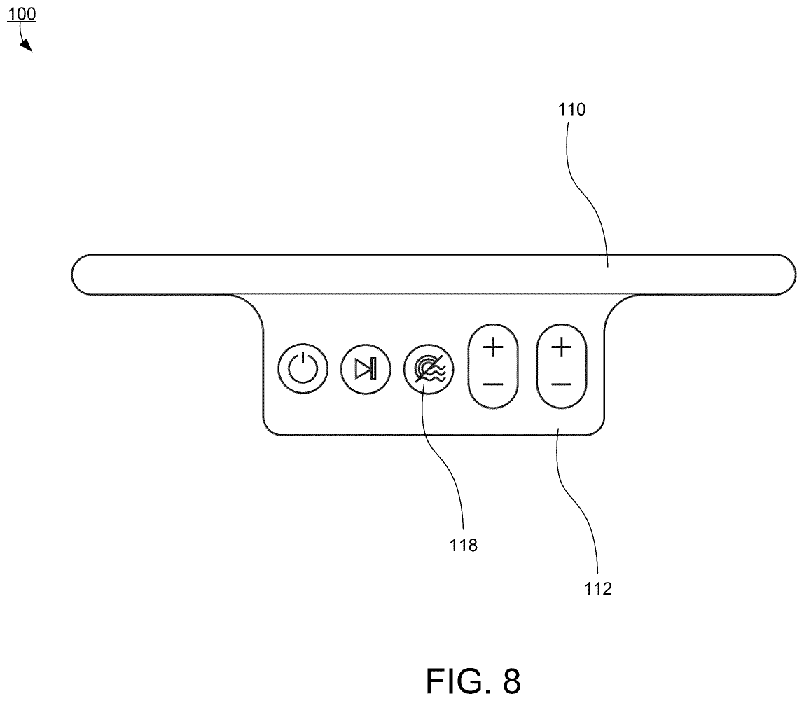

FIG. 8 is a side view of an example vibroacoustic device 100, according to some aspects of the present disclosure. In some embodiments, vibroacoustic device 100 can include various control features 118 including, but not limited to, an on/off switch, sound option switch, heat/cool feature, volume adjust, and vibration adjust, among others. Various methods may be used to control vibroacoustic device 100, including control features 118 directly on the product, control remotely via Bluetooth/Infrared Light, control via smart device (phone, smartwatch, etc.), gesture/motion control, remote control 200, sensors (e.g., motion sensors, weight sensors, etc.) and combinations thereof. Other methods may also be used, as appreciated by one having ordinary skill in the art.

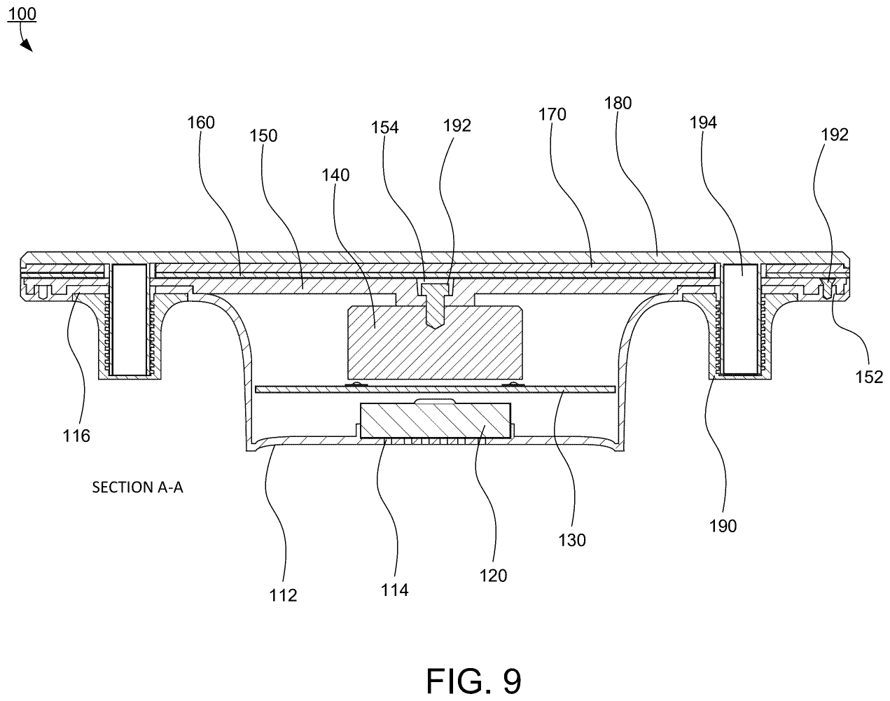

FIG. 9 is a cross-section view through section A-A in FIG. 5 of an example vibroacoustic device 100, according to some aspects of the present disclosure. Vibroacoustic device 100 is illustrated in a closed position with no gap between between the first side and the second side, in contrast to FIG. 6 and FIG. 7. Instead, housing 110 encases, within storage compartment 112, speaker 120, circuit board 130, and vibroacoustic speaker 140. Assembly cover plate 150 is secured to housing 110 using aperture 152, central aperture 154, and fastener 192. Housing 110, assembly cover plate 150, and the contents encased therewithin are secured to top connection plate 180. More specifically, bolt 194 is attached to top connection plate 180 and received through corresponding holes on housing 110 (e.g., at fastening areas 116) and assembly cover plate 150.

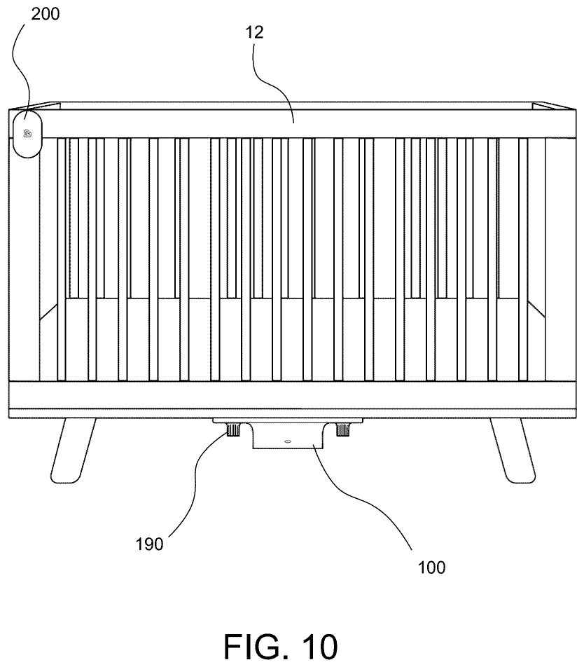

FIG. 10 illustrates an example vibroacoustic device 100 attached to a crib 12, according to some aspects of the present disclosure. Crib 12 may have a frame that secures a mattress, to which the vibroacoustic device 100 is attached.

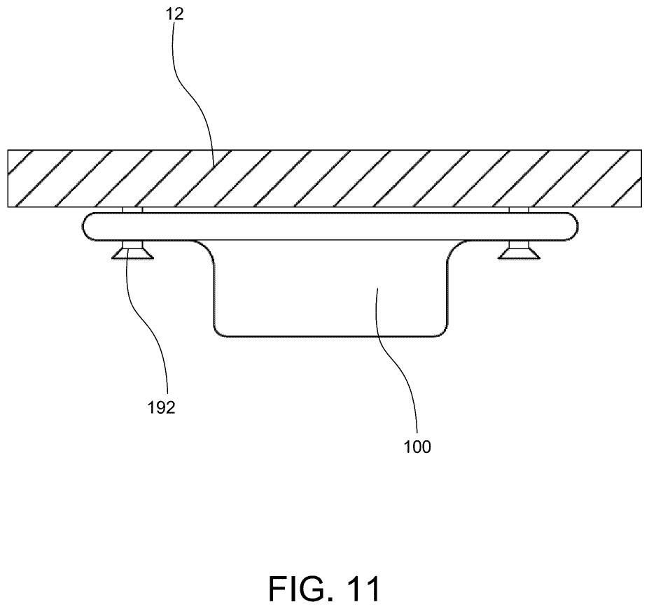

FIG. 11 illustrates attachment of an example vibroacoustic device 100 to a crib 12, according to some aspects of the present disclosure. The vibroacoustic device 100 according to the present subject disclosure is versatile in that it may be used in various ways. As depicted in FIG. 11, vibroacoustic device 100 is connected to a standard crib 12. A bottom portion of crib 12 may be a board, which may be wooden, plastic or other suitable material. Housing 110 of vibroacoustic device 100 can be attached to the board. For example, connectors (e.g., screws, bolts, fasteners, etc.) may be used to attach longitudinal ends 110a, 110b of housing 110 to the board. In some embodiments, the board may be positioned above a wire frame or may be attached to any part of the frame structure of the crib 12, such as the side railing slats.

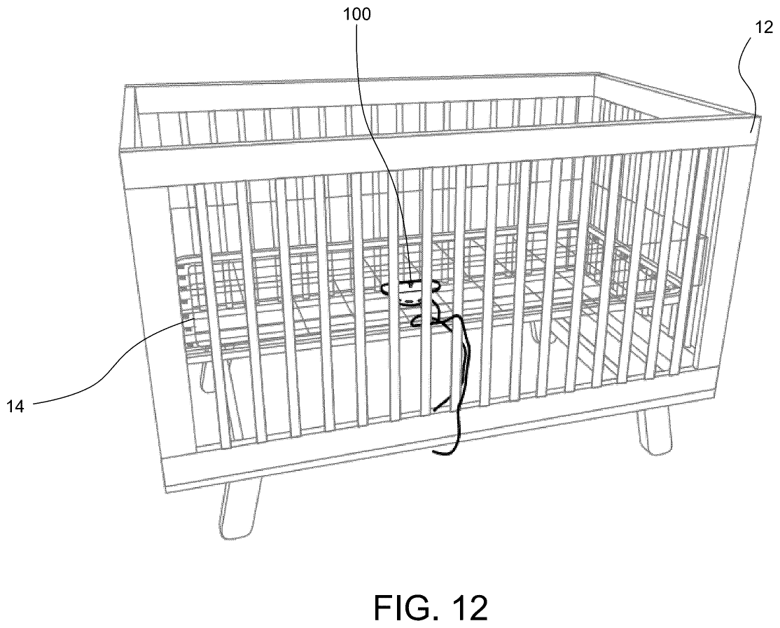

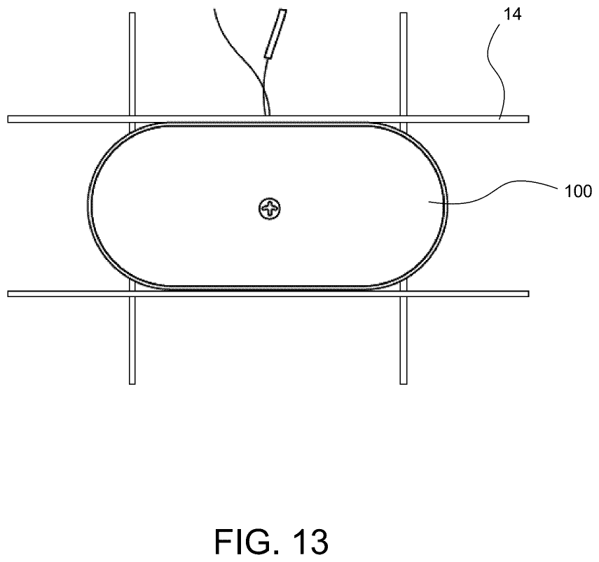

FIG. 12 and FIG. 13 illustrate an example vibroacoustic device 100 attached to a frame of a crib, according to some aspects of the present disclosure. FIG. 12 shows another method of attaching vibroacoustic device 100 to a crib 12. Some such cribs 12 contain a wire frame 14, which serves to support a mattress from underneath.

FIG. 13 shows a closer view of vibroacoustic device 100 attached to the crib 12. The vibroacoustic device 100 may be inserted between vertical and/or horizontal wires within the frame 14 and locked in by extending the longitudinal ends 110a, 110b of housing 110 over a top side of the wires, while the narrower bottom portion (e.g., the portion including storage compartment 112) extends downward and underneath the wire frame.

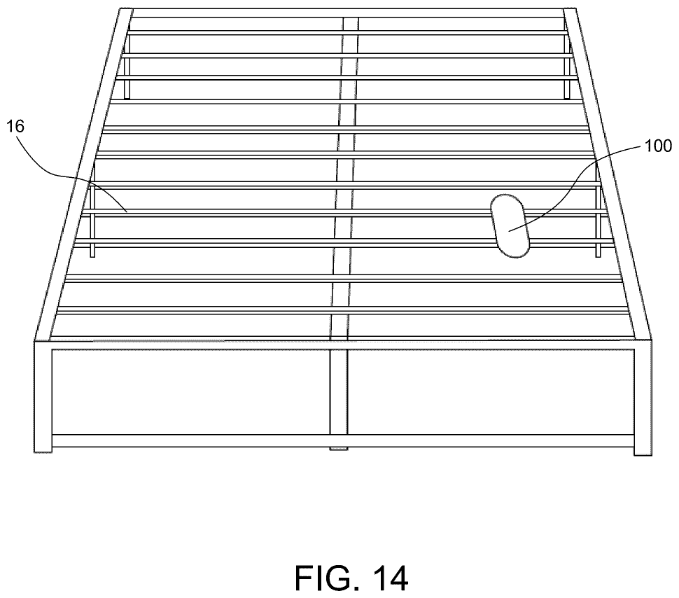

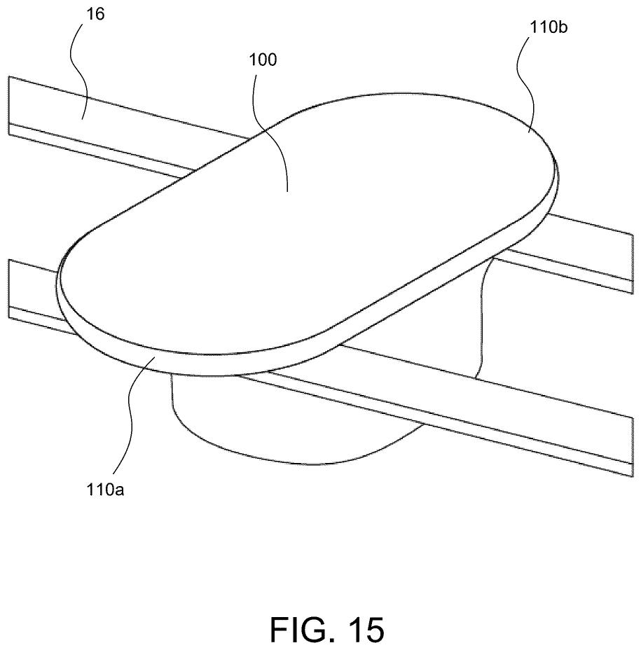

FIG. 14 and FIG. 15 illustrate an example vibroacoustic device 100 positioned within parallel slats 16 of a frame 14 of a bed, according to some aspects of the present disclosure. FIG. 15 shows a closer view of vibroacoustic device 100 positioned within the slats 16. Vibroacoustic device 100 may be positioned in between two slats 16 such that the elongated portion of housing 110 is positioned above the top planar surface of two adjacent slats 16, and the bottom portion (e.g., the portion including storage compartment 112) hangs beneath the bottom surface of the two adjacent slats 16. Positioning of the vibroacoustic device 100 in the manner shown involves several steps. First, the longitudinal ends 110a, 110b of the housing 110 are positioned such that they are parallel with the slats 16. Next, the housing 110 or top portion of the vibroacoustic device 100 is lifted above the top surface of the slats 16. Finally, vibroacoustic device 100 is turned such that the longitudinal ends 110a, 110b are positioned perpendicular to the parallel slats 16, as shown in FIG. 14 and FIG. 15. This position then “locks” the vibroacoustic device 100 in between the slats 16.

FIG. 16 illustrates an example vibroacoustic device 100 attaching to a slat of a frame of a bed, according to some aspects of the present disclosure. More specifically, vibroacoustic device 100 can be attached to one or more slats 16 of a frame 14 of a bed or crib 12. For example, first rattle reduction layer 160 and second rattle reduction layer 170 may sandwich rods or slats. For example, first rattle reduction layer 160 can be secured against assembly cover plate 150 and one side of the slats, while second rattle reduction layer 170 is secured against top connection plate 180 and another side of the slats. Consequently, a first side having housing 110, assembly cover plate 150, contents stored within housing 110 and assembly cover plate 150 (e.g., speaker 120, circuit board 130, and/or vibroacoustic speaker stored in storage compartment 112), and first rattle reduction layer 160 attach to a second side having second rattle reduction layer 170 and top connection plate 180 and sandwiches slats between the first side and the second side. Vibroacoustic device 100 is thereby secured to the bed. First rattle reduction layer 160 and second rattle reduction layer 170 provide noise and vibration reduction and/or absorption, to prevent rattling of vibroacoustic device 100 against bed slats (or other object that vibroacoustic device 100 is secured to) during operation.

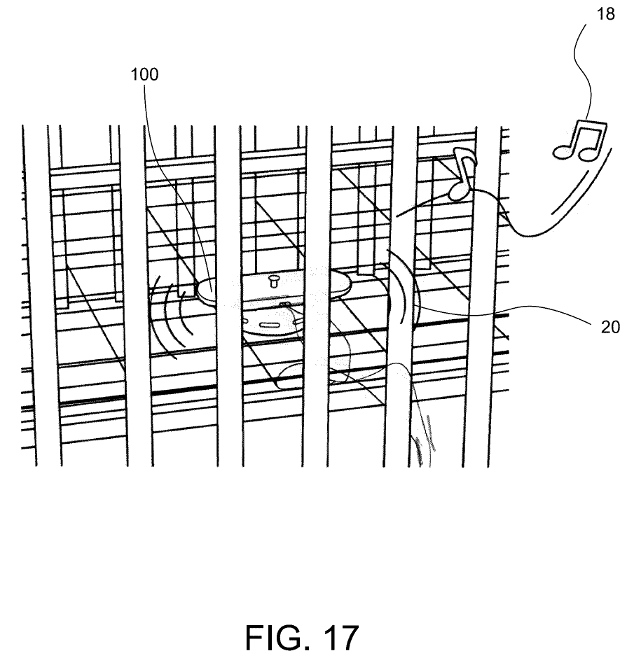

FIG. 17 is another view of a crib incorporating an example vibroacoustic device 100, according to some aspects of the present disclosure. As illustrated, vibroacoustic device 100 provides acoustic sound 18 and vibration 20. For example, vibroacoustic device 100 can provide audible soothing sound 18 and vibration 20 that correlate with the acoustic sound 18. The audible sound may include some additional sounds such as a heartbeat sound and the mother's voice sound among other sounds.

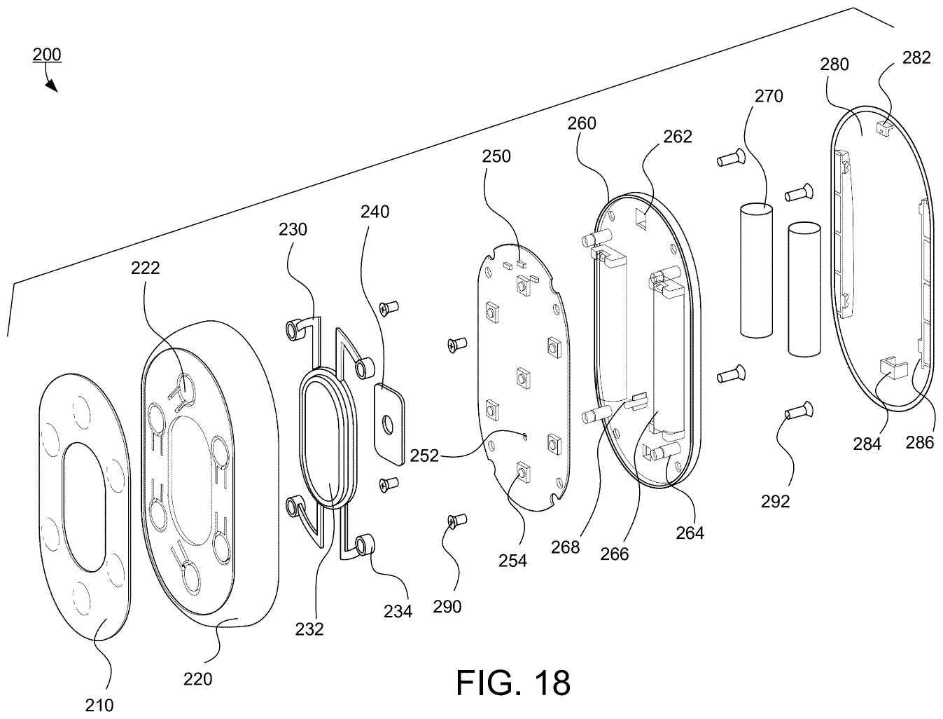

FIG. 18 is an exploded view of an example remote control 200, according to some aspects of the present disclosure. Remote control 200 can have a capsule-like shape. Remote control 200 can include an interface board 210, a housing 220, a button panel 230, a magnet 240, a circuit board 250, an inner housing 260, a power supply 270, and a cover 280.

Interface board 210 can be disposed on housing 220. Interface board 210 provides a surface that can be easily removed for cleaning. In some embodiments, interface board 210 may have an aperture therein to provide access to a control (e.g., button panel 230). Interface board 210 may be constructed such that interface board 210 flexes to press against and actuate button panel 230 when pressed. In some embodiments, housing 220 may have button actuators 222 between interface board 210 and button panel 230, such that when interface board 210 is pressed and flexes against the button actuators 222, the button actuators 222 press against button panel 230.

Button panel 230 are configured to receive pressure, generate signals, and send the signals to circuit board 250. Button panel 230 can include a center button 232 that comes in contact with a PCB button 254 in a center of circuit board 250. In some embodiments, center button 232 can have a concave curvature to accommodate dock 300. Button panel 230 can include buttons 234 that are configured to come into contact with interface board 210 when actuators 222 of interface board 210 are pressed. Buttons 234 can then press against and come in contact with PCB buttons 254 in corresponding positions.

Circuit board 250 is configured to receive signals from button panel 230. Circuit board 250 can include an aperture 252 to facilitate proper positioning of circuit board 250 in relation to interface board 210, housing 220, button panel 230, and inner housing 260. For example, inner housing 260 can include a positioning protrusion 268 to be inserted into aperture 252. Circuit board 250 can generate and send signals to another device (e.g., vibroacoustic device 100, a mobile device, etc.). For example, a user may press a button 234 (e.g., by pressing against a corresponding portion of interface board 210) that indicates the user wants to increase a vibration intensity. Circuit board 250 can receive the signal from the button 234 (e.g., from the contact of button 234 against PCB button 254) and, in response to receiving the signal, generate and send a command signal to vibroacoustic device 100, which can then increase the vibration intensity.

Referring back to magnet 240, magnet 240 is operable to facilitate securing of remote control 200 to a dock 300. In some embodiments, dock 300 may also be a charging dock configured to charge power supply 270.

Inner housing 260 can provide a layer of protection between a power supply 270 and circuit board 250. Additionally inner housing 260 provides an interface to allow power from power supply 270 to power circuit board 250. Inner housing 260 can include a securing recess 262 to receive and secure a securing protrusion 282 of cover 280. Inner housing 260 can also include a fastener aperture 264 to receive fastener 290 and thereby secure circuit board 250. Inner housing 260 can also include a battery housing 266. For example, in some embodiments, power supply 270 can be a battery and battery housing 266 can be configured to secure the battery and direct power from the battery to the circuit board 250. Fasteners 290, 292 can be used with inner housing 260 to secure components together. For example, fastener 290 can fasten buttons with circuit board 250 and fastener 292 can fasten inner housing 260 with housing 220.

Cover 280 and housing 220 encase button panel 230, magnet 240, circuit board 250, inner housing 260, and power supply 270. Cover 280 can include a securing protrusion 282 configured to mate with securing recess 262 to secure cover 280 to inner housing 260. In some embodiments, securing protrusion 282 can be configured to abut against a positioning shoulder 269 (obscured from view) of inner housing 260. Cover 280 can also include a securing recess 284 to receive and secure a securing protrusion (obscured from view) of inner housing 260. Cover 280 can also include guides 286 to provide a more controlled, longitudinal movement of cover 280 in relation to inner housing 260 and housing 220. For example, cover 280 can slide longitudinally against inner housing 260 to either secure and/or remove cover 280 from inner housing 260 and housing 220.

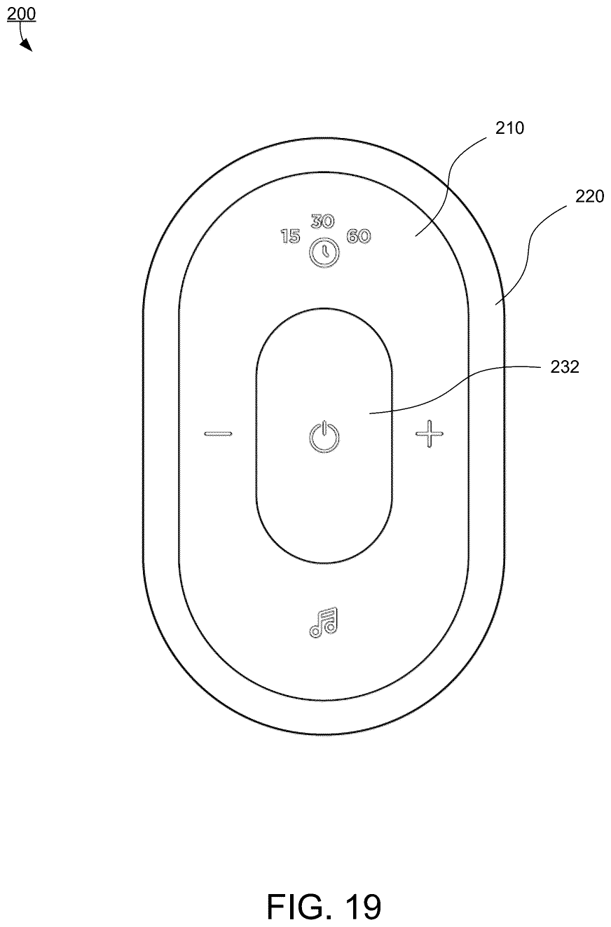

FIG. 19 is a front view of an example remote control 200, according to some aspects of the present disclosure. As shown, interface board 210 and center button 232 are visible and can receive input from a user.

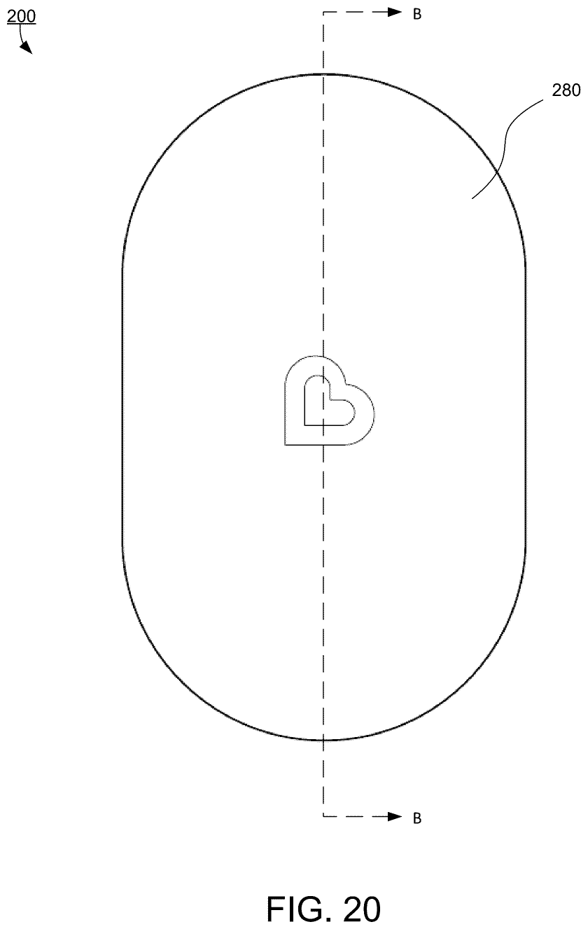

FIG. 20 is a rear view of an example remote control 200, according to some aspects of the present disclosure. In the closed position, cover 280 covers the rear face of remote control 200.

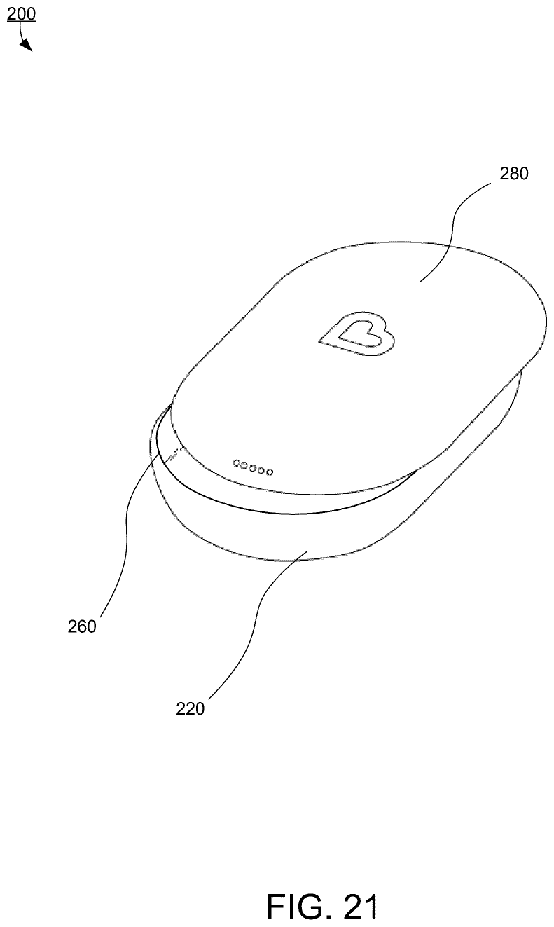

FIG. 21 is a perspective view of an example remote control 200, according to some aspects of the present disclosure. More specifically, FIG. 21 illustrates cover 280 in a semi-open position, such that cover 280 is sliding along housing 220 and inner housing 260. Cover 280 can slide downwards to cover inner housing 260 and/or slide upwards to reveal inner housing 260.

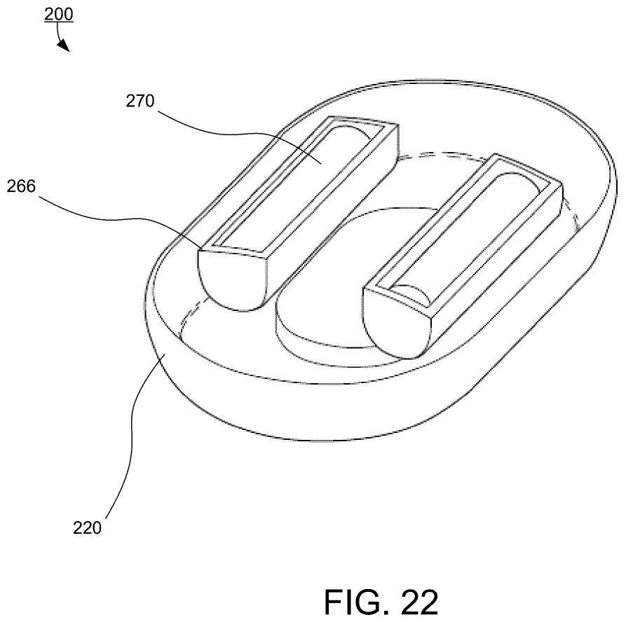

FIG. 22 is a perspective view of a battery housing of an example remote control 200, according to some aspects of the present disclosure. When cover 280 is removed from housing 220 and inner housing 260, battery housing 266 is accessible and a power supply 270 (e.g., a battery) can be placed therein.

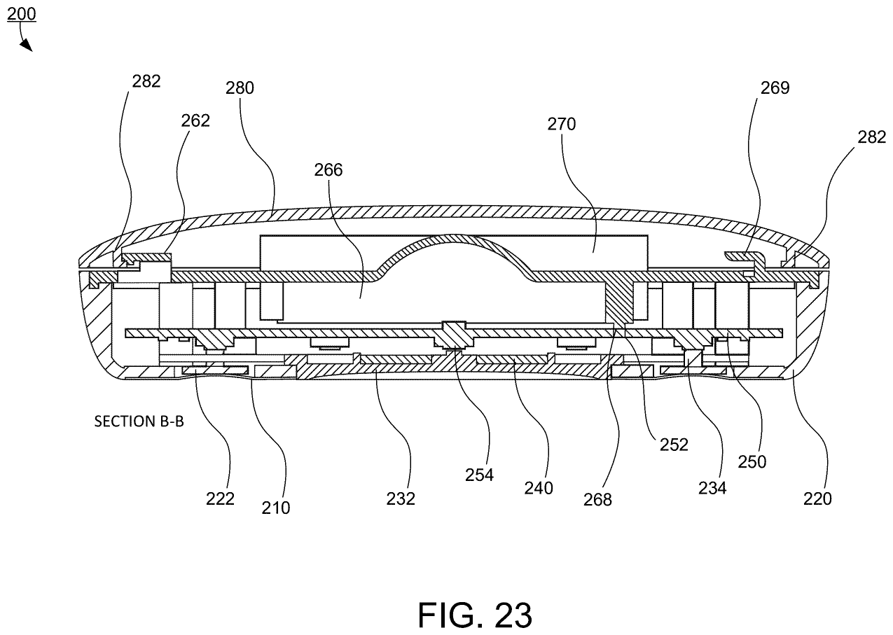

FIG. 23 is a cross-section view through section B-B in FIG. 20 of an example remote control, according to some aspects of the present disclosure. Remote control 200 is depicted facing down, such that the front (e.g., the interface board 210) of the remote control 200 faces downwards. Interface board 210 sits within a recess of housing 220 and is contact with buttons 234. Additionally, center button 232 sits within a center of interface board 210. Center button 232 also may have a concave curvature that matches a corresponding convex curvature of a dock 300 (e.g., mounting surface 310 of dock 300). Aperture 252 of circuit board 250 receives positioning protrusion 268 of inner housing 260 to properly position circuit board 250 within inner housing 260 and housing 220 to ensure contact of center button 232 and buttons 234 with PCB buttons 254, such that pressing center button 232 and/or buttons 234 (e.g., by pressing interface board 210 against actuators 222, which actuates button 234) activates PCB buttons 254.

When cover 280 is in the closed position (e.g., covering inner housing 260), one securing protrusion 282 can be positioned away from positioning shoulder 269, while another securing protrusion 282 can be positioned within securing recess 262 of inner housing 260. When removing cover 280, cover 280 slides leftwards (with respect to FIG. 23) to free the leftmost securing protrusion 282 from securing recess 262, while causing the rightmost securing protrusion 282 to abut against positioning shoulder 269. When the rightmost securing protrusion 282 abuts against positioning shoulder 269, cover 280 can be pulled upwards and/or away from inner housing 260 to be removed. In some embodiments, Cover 280 can have a curvature to provide space for power supply 270, which is secured by battery housing 266.

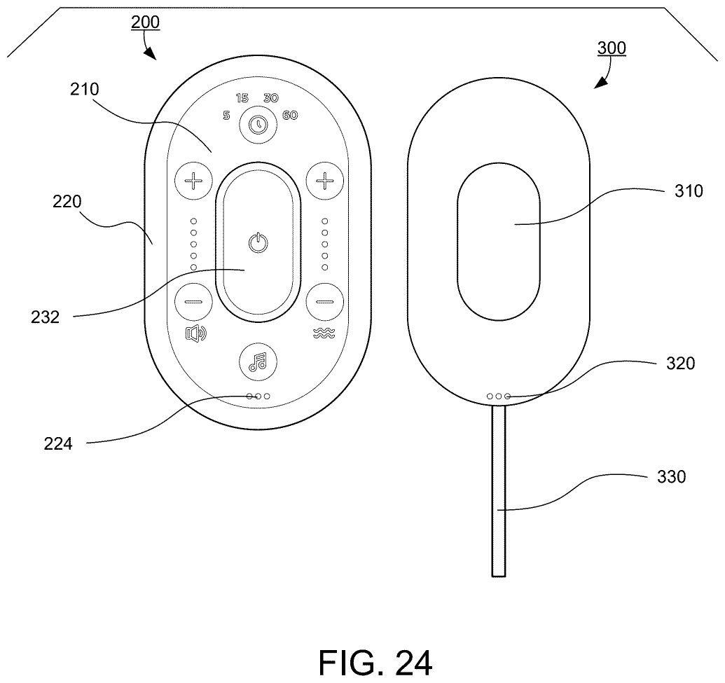

FIG. 24 illustrates an example remote control 200 and an example dock 300, according to some aspects of the present disclosure. As discussed above, remote control 200 can have center button 232, which can have a curvature that corresponds to a curvature of mounting surface 310. Mounting surface 310 can also include a magnet disposed therein. Mounting surface 310 can receive and secure remote control 200 using the magnet disposed in mounting surface 310 and magnet 240 disposed adjacent to center button 232. Remote control 200 can also include connector 224 configured to mate with connector 320. Connectors 224, 320 can allow dock 300 to charge remote control 200. In some embodiments, dock 300 may include a power cable 330.

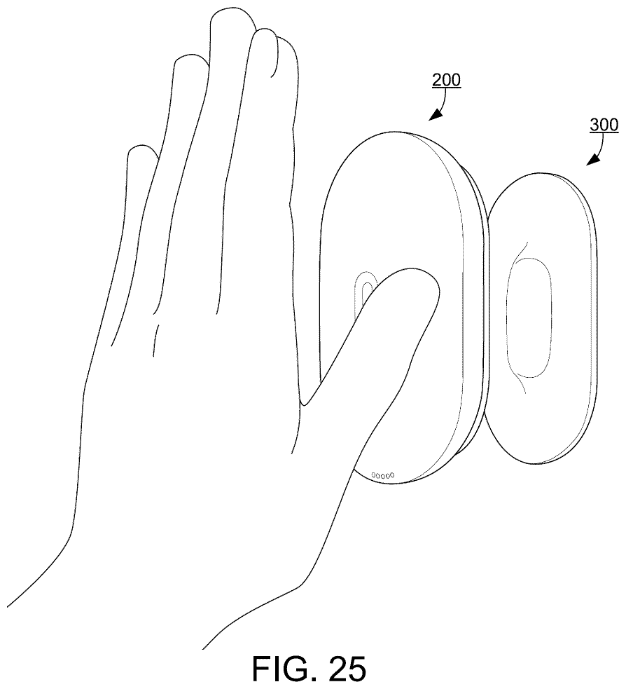

FIG. 25 illustrates a user attaching an example remote control 200 to an example dock 300, according to some aspects of the present disclosure.

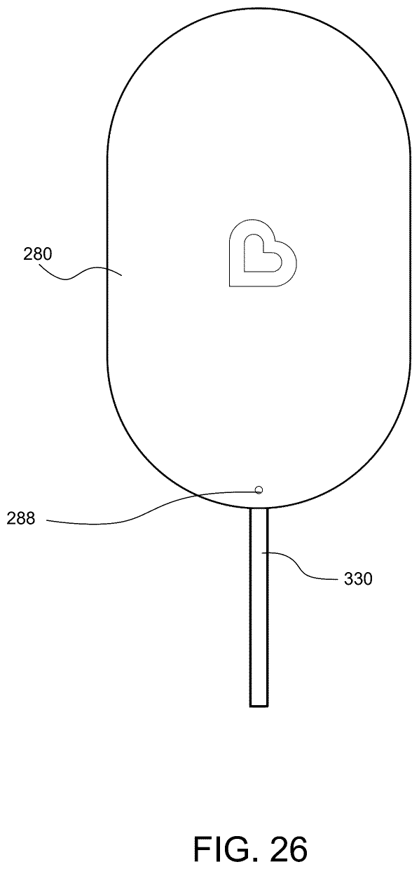

FIG. 26 illustrates an example remote control 200 attached to an example dock 300, according to some aspects of the present disclosure. In some embodiments, remote control 200 can include an indicator 288, such as an light emitting diode (LED) to provide additional information (e.g., remaining power, current mode, etc.).

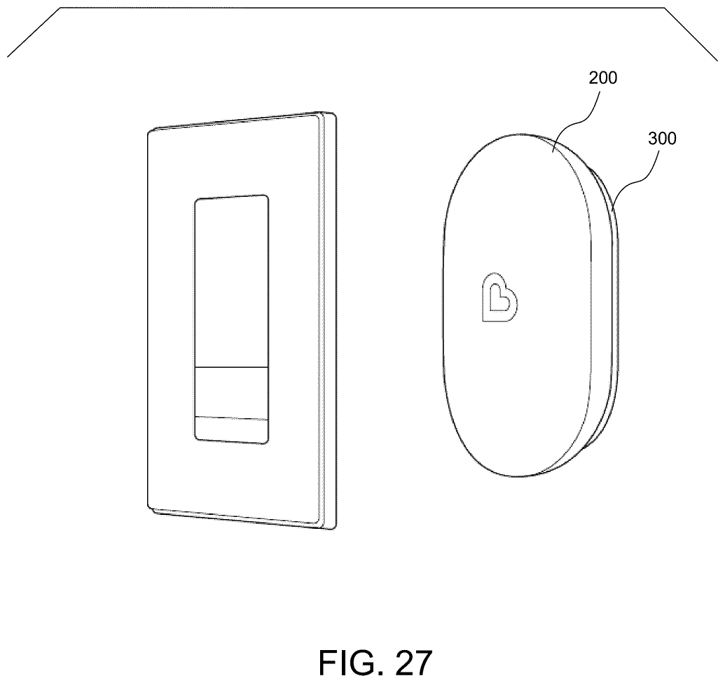

FIG. 27 illustrates an example remote control 200 attached to an example dock 300, according to some aspects of the present disclosure. Dock 300 can be placed in various different places across a home, such as on a wall near a light switch for ease of access.

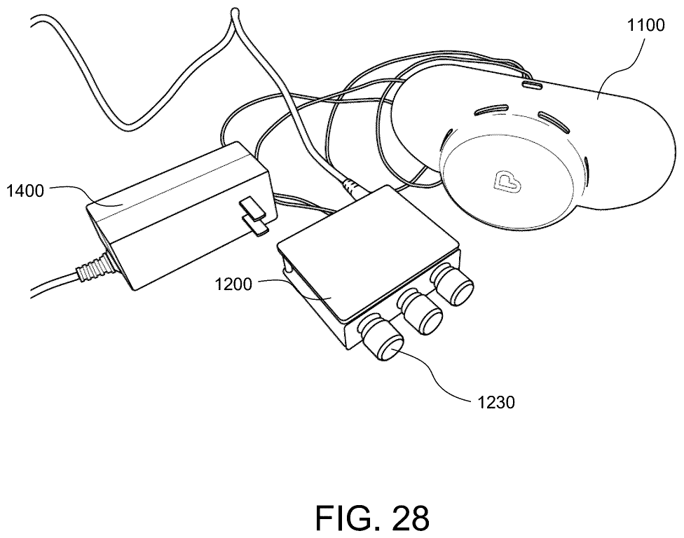

FIG. 28 illustrates another exemplary embodiment including an example vibroacoustic device 1100, according to some aspects of the present disclosure. FIG. 28 shows an exemplary vibroacoustic device 1100 with separate controls control interface 1200 and a power supply 1400 (e.g., a standard AC wall adapter), in communication through various wire connections. The control interface 1200 includes controls 1230 in the form of various buttons and switches. In this particular exemplary embodiment, the buttons and switches are separate from the body of the vibroacoustic device 1100.

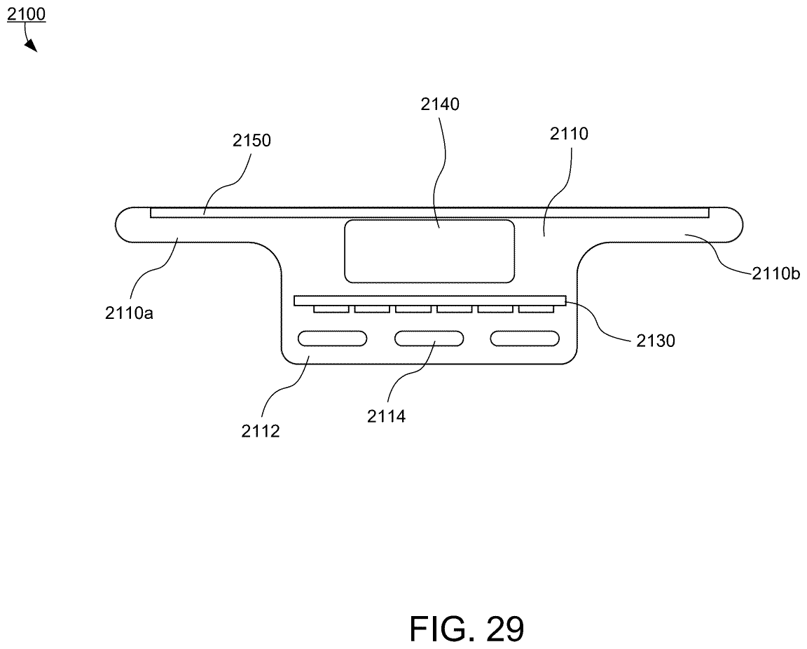

FIG. 29 is a cross sectional view of an example vibroacoustic device 2100, according to some aspects of the present disclosure. The vibroacoustic device 2100 has a housing 110 having an elongated and wider top portion with longitudinal ends 2110a, 2110b and a narrower bottom portion for a storage compartment 2112. The top side of the housing 2110 can include a solid material (such as wood) assembly cover 2150 to more securely fasten to a bed slat, as described above. Alternatively, the top portion and assembly cover 2150 can be a two-piece separable construction in which the assembly cover 2150 becomes a top plate and is separated from the housing 2110 and placed on one side of an object and the assembly cover 2150 is placed on another side of the object and both the housing 2110 and the assembly cover 2150 are connected to each other to secure the vibroacoustic device 2100 to the object as discussed above. A vibroacoustic speaker 2140, which generates sound and vibration, is positioned within the housing 2110 of the vibroacoustic device 2100 directly underneath the assembly cover 2150. A printed circuit board (PCB) 2130 is positioned underneath the vibroacoustic speaker 2140, and includes the various electronic control tools, circuitry, modules, memories, and sound required to operate the vibroacoustic speaker 2140. Housing 2110 can also include apertures 2114 to allow for dissipation of heat generated by PCB 2130, and also provide further sound distribution.

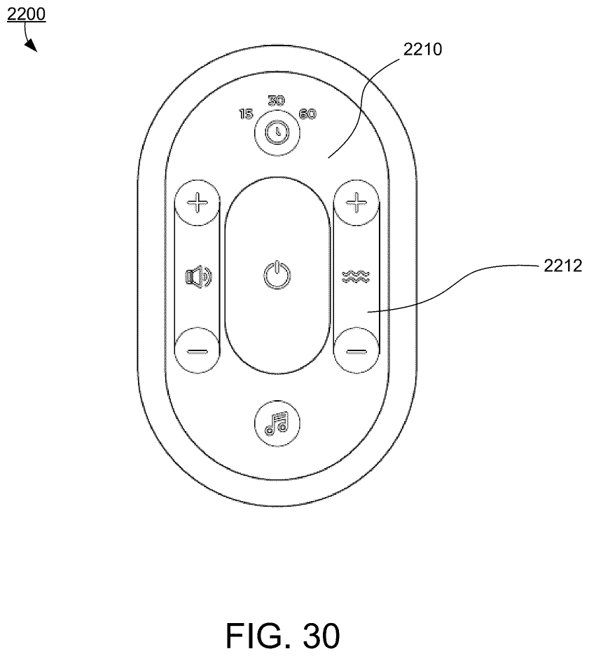

FIG. 30 illustrates an example remote control 2200, according to some aspects of the present disclosure. Remote control 2200 can have a different interface board 2210 having a different layout of buttons 2212.

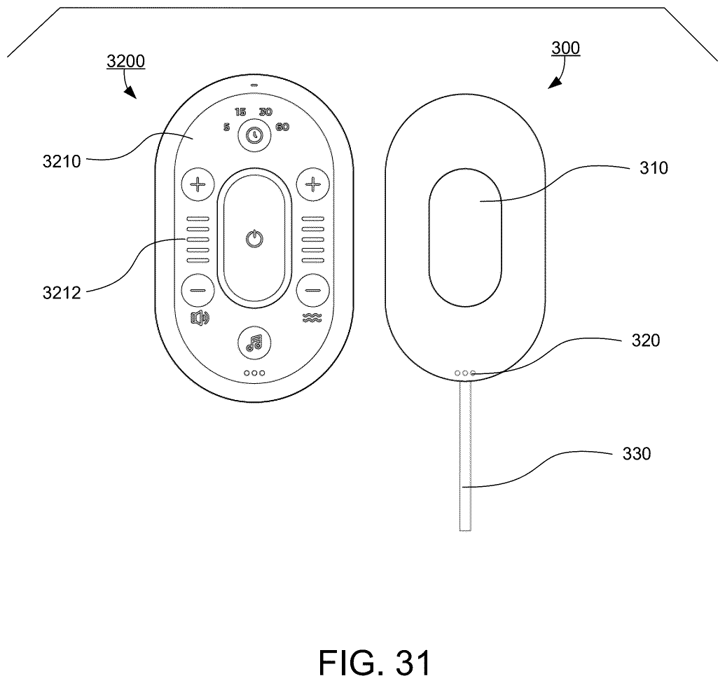

FIG. 31 illustrates an example remote control 3200 and an example dock 300, according to some aspects of the present disclosure. Remote control 3200 can also have a different interface board 3210 having yet another layout of buttons 3212. Additionally, various different layouts can be used for remote controls 200, 2200, 3200, while also having a curvature to attach to dock 300.

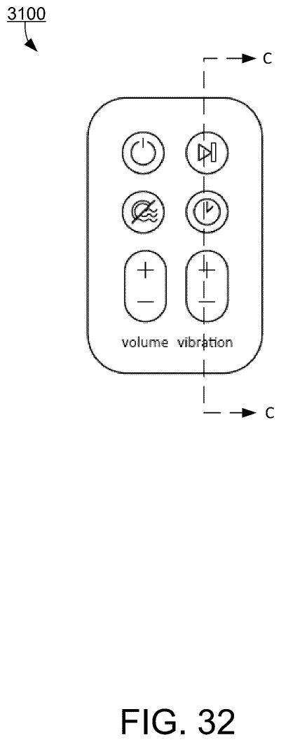

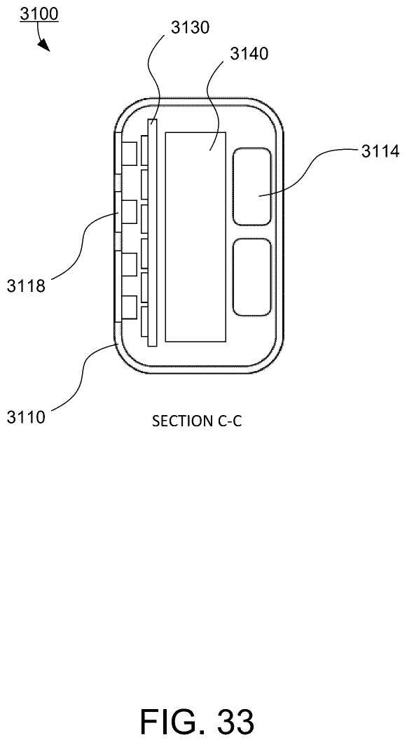

FIG. 32 illustrates an example vibroacoustic device 3100, according to some aspects of the present disclosure. FIG. 33 is a cross-section view through section C-C in FIG. 32, according to some aspects of the present disclosure. The vibroacoustic device 3100 should be accessible to make repairs, and/or be able to change or charge its internal battery. The control buttons 3118 and switches on housing 3110 can be similar to those shown in FIG. 8 and are operable to communicate with PCB 3130 to control vibroacoustic speaker 3140. Housing 3110 can also have apertures 3114 to allow heat dissipation and sound to flow therethrough.

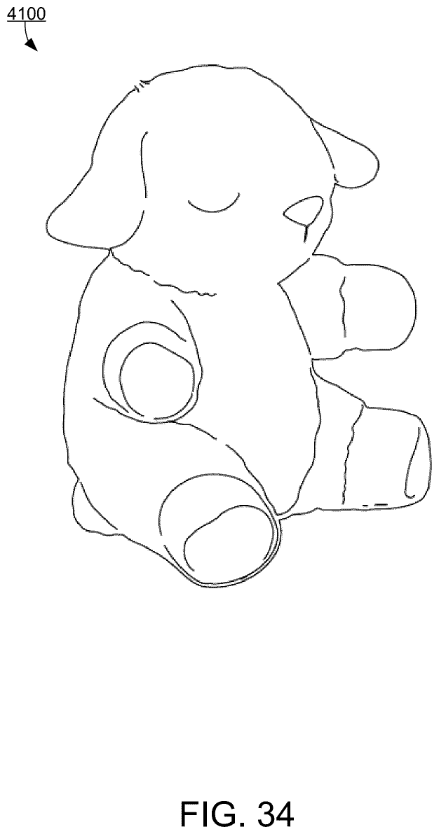

FIG. 34 is a view of a stuffed animal incorporating a vibroacoustic device 4100, according to some aspects of the present disclosure. While, FIG. 34 illustrates a stuffed animal as an example, other products may also be incorporated with the disclosed vibroacoustic technology. For example, the disclosed vibroacoustic technology can be incorporated in stuffed dolls/animals, pillows, nursery pillows, body pillows, swings, bouncers, strollers, car seats, changers, pads, mattresses, blankets, clothes, among others. In some examples, the vibroacoustic device 4100 may be the product or may be positioned within the interior of the product (e.g., inside the stuffed animal) or a designated pocket on the product (e.g., blanket). Additionally, the present vibroacoustic technology can also be used in other products including, but not limited to, bassinets, cribs, beds, soft goods (e.g., clothing, swaddles, blankets, pillow covers, bed covers, chairs, sofas, baby loungers, etc.), bathtubs and related accessories, strollers, jumpers, swings, baby carriers, charging pads/stations, car seats, toys, body pillows, massagers, etc.

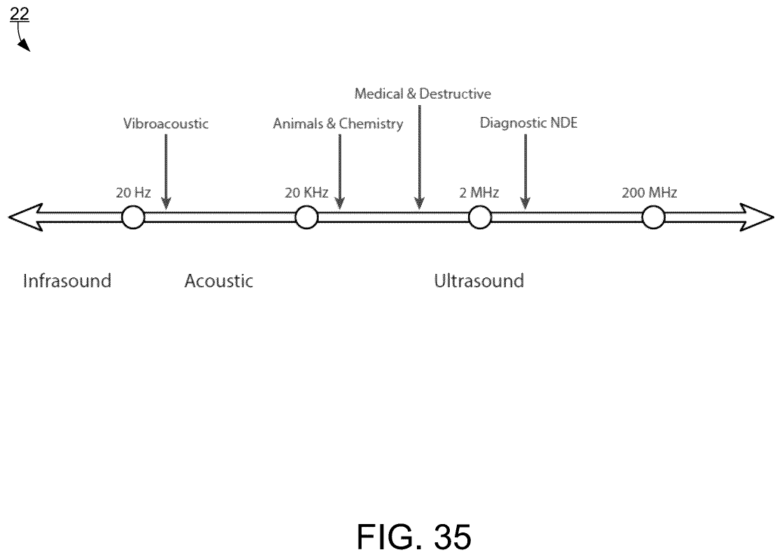

FIG. 35 shows an operation frequency of vibroacoustic therapy as compared to other acoustic uses, according to some aspects of the present disclosure.

As shown in the sound frequency scale 22 of FIG. 35, vibroacoustic therapy involves sound therapy that uses audible sound vibrations. This reduces anxiety symptoms, supports sleep, invokes relaxation, and alleviates stress. The process works by passing low frequency sine wave vibrations into the body, which is believed to have deeper physiological and emotional effects compared to just gentle vibrations.

Vibroacoustic therapy is different from gentle vibration because it involves delivering sound waves and vibrations simultaneously. This dual sensory stimulation is believed to have deeper physiological and emotional effects compared to just gentle vibration. Such dual sensory delivery is thought to stimulate the nervous system, promote relaxation, and potentially relieve pain or anxiety.

Vibroacoustic therapy is effective because sound penetrates deeper—vibroacoustic therapy provides massage therapy to muscles and joints that hand/mechanical massage cannot reach. Ultrasound is a well-known and accepted sound technology for viewing tissue inside a body and it operates at 20 KHz+. Meanwhile, as shown in FIG. 35, vibroacoustic therapy operates in the acoustic region, which is 20 Hz to 20 KHz. More specifically, vibroacoustic therapy operates closer to 20 Hz.

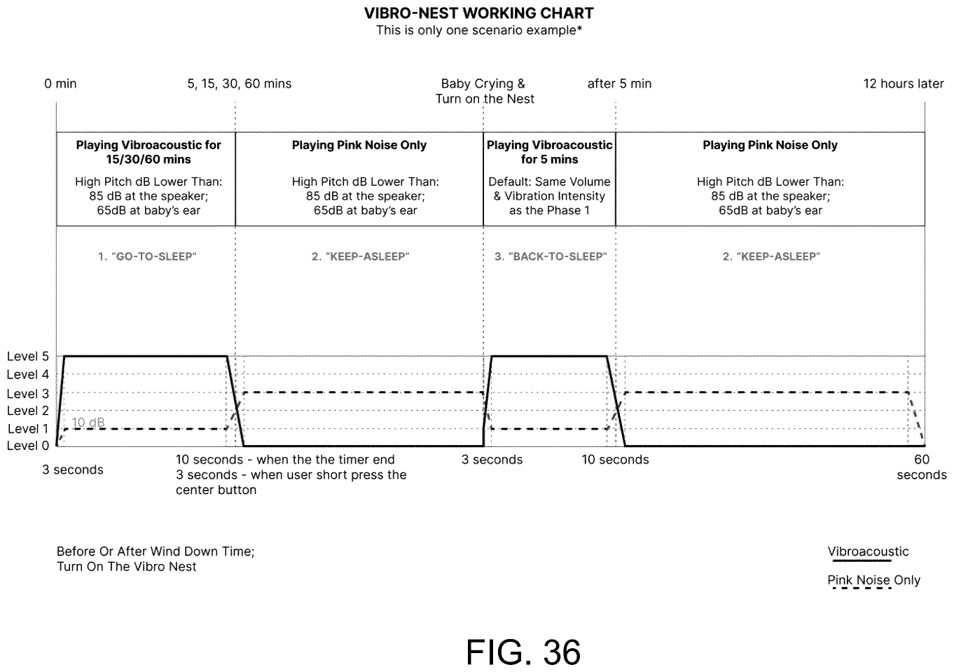

FIG. 36 illustrates example operating levels of an example vibroacoustic device 100, according to some aspects of the present disclosure. Vibroacoustic device 100 is configured to operate in various different modes. For example, a first mode can be designed to facilitate falling asleep. The first mode can include highest level of vibration intensity, while also including a minimal amount of acoustic noise. Vibroacoustic device 100 and transition to a second mode by gradually increasing and/or decreasing vibrations and/or acoustic noise. A second mode can be designed to maintain sleep by stopping vibrations and increasing acoustic noise (e.g., pink noise). Modes can be set for pre-determined durations. For example, when a child wakes up in the middle of the night, a user can press a button on remote control 200 to set vibroacoustic device 100 in the first mode to facilitate the child in falling back asleep. After the pre-determined duration (e.g., when the child has likely fallen asleep), the vibroacoustic device can return to the second mode to keep the child asleep.

In addition to the path shown in FIG. 36, it is to be understood that another aspect of this invention is the ability for the vibroacoustic device 100 to coordinate and overlay acoustic sounds and vibrations at various vibration and acoustic sound levels. For example, during the first “GO-TO-SLEEP” phase a first vibration from the vibroacoustic speaker 140 may mimic the heartbeat of the mother and can be produced at a first vibrational frequency. Simultaneously, a first sound from the speaker 120 such as a lullaby or pink noise can be produced at a first acoustic sound frequency. The first phase can be programmed at any period of time, for example 5, 15, 30 or 60 mins. As the phase progresses, the vibrational frequency of the mothers heartbeat can be reduced and slowed to mimic the mother's body moving into a sleep state. Likewise, the first acoustic sound frequency of the first sound can also be reduced to coincide with the reduction and slowing down of the mothers heartbeat so that when the “KEEP-ASLEEP” phase has begun, the first sound may be substantially low and/or completely eliminated. If, in the third phase “BACK-TO-SLEEP”, the infant wakes up, the initial vibration and acoustic level can be restored and eventually lowered to encourage the infant to go back to sleep. Another phase named “WAKE-UP” can be included which reverses the “GO-TO-SLEEP” phase to gradually wake up the sleeping infant when it is time to gently wake up the infant. It is to be understood that numerous routines are possible in the various phases and that the vibrational frequency of the vibroacoustic speaker 140 and the acoustic sound levels of the speaker 120 may be coordinated and overlayed at various preferred vibration and acoustic sound levels.

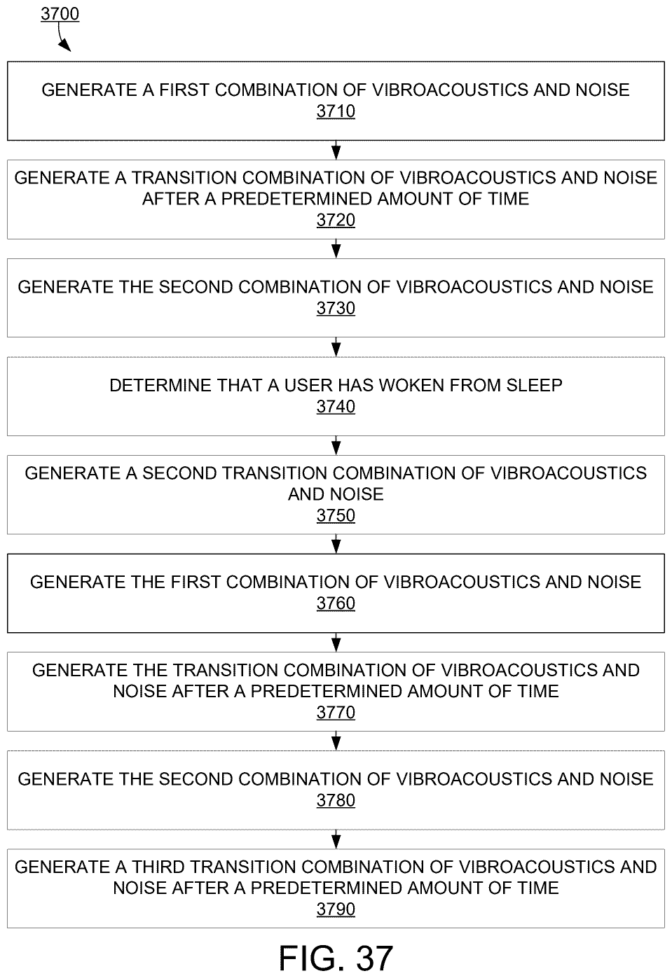

FIG. 37 illustrates an example method for facilitating sleep and/or rest using a vibroacoustic device, according to some aspects of the present disclosure. Although the example method 3700 depicts a particular sequence of operations, the sequence may be altered without departing from the scope of the present disclosure. For example, some of the operations depicted may be performed in parallel or in a different sequence that does not materially affect the function of the method 3700. In other examples, different components of an example device or system that implements the method 3700 may perform functions at substantially the same time or in a specific sequence.

At operation 3710, a vibroacoustic device (e.g., vibroacoustic device 100) generates a first combination of vibroacoustics and noise. For example, the vibroacoustic device can generate a higher level of vibroacoustic vibrations and a relatively low level of noise to facilitate falling asleep.

At operation 3720, the vibroacoustic device generates a transition combination of vibroacoustics and noise (e.g., after a predetermined amount of time). The transition combination can be a combination that is a smooth transition from the first combination to a second combination of vibroacoustics and noise. For example, the vibroacoustic device can generate a decreasing intensity of vibroacoustic vibrations from the higher level of vibroacoustic vibrations to a low level or absence of vibroacoustic vibrations and an increasing level of pink noise from the relatively low level of noise to a higher level of pink noise.

At operation 3730, the vibroacoustic device generates the second combination of vibroacoustics and noise. For example, the vibroacoustic device can generate an intensity of vibroacoustic vibrations that is lower than the higher level of vibroacoustic vibrations and a level of pink noise that is higher than the relatively low level of noise of the first combination.

At operation 3740, the vibroacoustic device determines that a user (e.g., a baby on the crib that the vibroacoustic device is attached to) has woken from sleep. For example, the user may toss and turn, cry, and/or perform other actions that are indicative of waking from sleep. In some embodiments, the vibroacoustic device can have sensors that are configured to capture data that is associated with these actions and determine, based on the captured data, that the user has woken from sleep. In some embodiments, a user may generate a command to the vibroacoustic device (e.g., using a remote control such as remote control 200) to generate vibroacoustics and noise, thereby indicating that the user has woken.

At operation 3750, the vibroacoustic device generates a second transition combination of vibroacoustics and noise. The second transition combination can be a combination that is a smooth transition from the second combination back to the first combination of vibroacoustics and noise. For example, the vibroacoustic device can generate an increasing intensity of vibroacoustic vibrations from the low level or absence of vibroacoustics vibrations to the higher level of vibroacoustic vibrations and a decreasing level of pink noise from the higher level of pink noise to the relatively lower level of noise.

At operation 3760, the vibroacoustic device generates the first combination of vibroacoustics and noise. For example, the vibroacoustic device can generate the higher level of vibroacoustic vibrations and the relatively lower level of noise to facilitate falling asleep.

At operation 3770, the vibroacoustic device generates the transition combination of vibroacoustics and noise (e.g., after a predetermined amount of time). For example, the vibroacoustic device can generate a decreasing intensity of vibroacoustic vibrations from the higher level of vibroacoustic vibrations to a low level or absence of vibroacoustic vibrations and an increasing level of pink noise from the relatively low level of noise to a higher level of pink noise.

At operation 3780, the vibroacoustic device generates the second combination of vibroacoustics and noise. For example, the vibroacoustic device can generate an increasing intensity of vibroacoustic vibrations from the low level or absence of vibroacoustics vibrations to the higher level of vibroacoustic vibrations and a decreasing level of pink noise from the higher level of pink noise to the relatively lower level of noise.

At operation 3790, the vibroacoustic device generates a third transition combination of vibroacoustics and noise (e.g., after a predetermined amount of time). The third transition combination can be a combination that is a smooth transition from the first and/or second combinations to an inactive status. For example, the third transition combination can decrease vibroacoustic vibrations and/or noise levels until the vibroacoustic device stops generating vibroacoustic vibrations and/or noise.

The illustrations and examples provided herein are for explanatory purposes and are not intended to limit the scope of the appended claims. It will be recognized by those skilled in the art that changes, or modifications may be made to the above-described embodiments without departing from the broad inventive concepts of the invention. It is understood therefore that the invention is not limited to the particular embodiments which are described but is intended to cover all modifications and changes within the scope and spirit of the subject disclosure.

The foregoing disclosure of the exemplary embodiments of the present subject disclosure has been presented for purposes of illustration and description. It is not intended to be exhaustive or to limit the subject disclosure to the precise forms disclosed. Many variations and modifications of the embodiments described herein will be apparent to one of ordinary skill in the art in light of the above disclosure. The scope of the subject disclosure is to be defined only by the claims appended hereto, and by their equivalents.

Further, in describing representative embodiments of the present subject disclosure, the specification may have presented the method and/or process of the present subject disclosure as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present subject disclosure should not be limited to the performance of their steps in the order written, and one skilled in the art can readily appreciate that the sequences may be varied and still remain within the spirit and scope of the present subject disclosure.

What is claimed is:

1. A vibroacoustic system, comprising:
a vibroacoustic device having:
a housing,
a vibroacoustic speaker disposed in the housing, the vibroacoustic speaker configured to generate vibrations, and
an acoustic speaker disposed in the housing, the acoustic speaker configured to generate acoustic sounds; and
control features configured to control the vibroacoustic device, wherein the control features cause the vibroacoustic device to generate coordinated vibrations and acoustic sounds.

2. The vibroacoustic system of claim 1, wherein the vibroacoustic device is configured to generate a first combination of vibrations and acoustic sounds and a second combination of vibrations and acoustic sounds, and wherein the first combination includes a higher level of vibrations and a lower level of noise compared to a lower level of vibrations and a higher level of noise of the second combination.

3. The vibroacoustic system of claim 1, wherein the vibroacoustic device is configured to generate a transition combination of vibrations and acoustic sounds to transition between a first combination of vibrations and acoustic sounds and a second combination of vibrations and acoustic sounds.

4. The vibroacoustic system of claim 1, wherein the housing is adapted to be positioned between slats.

5. The vibroacoustic system of claim 1, wherein the vibroacoustic device further includes a connection plate, wherein the connection plate is operable to be secured to the housing.

6. The vibroacoustic system of claim 5, wherein the connection plate and the housing are operable to secure slats therebetween.

7. The vibroacoustic system of claim 5, wherein the housing has an elongated portion, and wherein the connection plate is secured to longitudinal ends of the housing with fasteners, and wherein the housing and the connection plate sandwich a slat.

8. The vibroacoustic system of claim 1, wherein the controls features are disposed on a remote control that is configured to communicate with the vibroacoustic device.

9. The vibroacoustic system of claim 8, further comprising:
a dock operable to receive and secure the remote control.

10. The vibroacoustic system of claim 1, wherein the controls features are disposed on the housing.

11. The vibroacoustic system of claim 1, wherein the vibroacoustic device further includes a printed circuit board (PCB) disposed within the housing, and wherein the PCB receives signals from the control features and causes the vibroacoustic speaker and the acoustic speaker to generate the vibrations and the acoustic sounds.

12. The vibroacoustic system of claim 1, wherein the vibrations mimic a heartbeat pattern.

13. The vibroacoustic system of claim 1, wherein the vibrations and acoustic sounds are overlayed over each other.

14. A vibroacoustic device, comprising:
a housing;
a vibroacoustic speaker disposed in the housing, the vibroacoustic speaker configured to generate vibrations;
an acoustic speaker disposed in the housing, the acoustic speaker configured to generate acoustic sound; and
a printed circuit board (PCB) in communication with the vibroacoustic speaker and the acoustic speaker, wherein the PCB causes the vibroacoustic speaker and the acoustic speaker to generate coordinated vibrations and acoustic sounds.

15. The vibroacoustic device of claim 14, wherein the vibroacoustic speaker and the acoustic speaker are configured to generate a first combination of vibrations and acoustic sounds and a second combination of vibrations and acoustic sounds, and wherein the first combination includes a higher level of vibrations and a lower level of noise compared to a lower level of vibrations and a higher level of noise of the second combination.

16. The vibroacoustic device of claim 14, wherein the vibroacoustic speaker and the acoustic speaker are configured to generate a transition combination of vibrations and acoustic sounds to transition between a first combination of vibrations and acoustic sounds and a second combination of vibrations and acoustic sounds.

17. The vibroacoustic device of claim 14, wherein the PCB is in communication with control features to receive commands to control the vibroacoustic speaker and the acoustic speaker.

18. The vibroacoustic device of claim 17, wherein the control features are disposed on a remote control that is configured to communicate with the PCB.

19. A method comprising:
generating, using a vibroacoustic device having a vibroacoustic speaker and an acoustic speaker, a first combination of vibrations and acoustic noises;
generating, using the vibroacoustic device, a transition combination of vibrations and acoustic noises, wherein the transition combination is a gradual transition of intensity of vibrations and volume of acoustic noises from a first intensity and volume of the first combination to a second intensity and volume of a second combination of vibrations and acoustic noises; and
generating, using the vibroacoustic device, the second combination of vibrations and acoustic noises.

20. The method of claim 19, further comprising:
generating, using the vibroacoustic device, a second transition combination of vibrations and acoustic noises, wherein the second transition combination is a gradual transition of intensity of vibrations and volume of acoustic noises from the second intensity and volume of the second combination to the first intensity and volume of the first combination.
